(19) United States
(12) Patent Application Publication
(10) Pub. No.: US 2025/0237060 A1
(43) Pub. Date: Jul. 24, 2025

(54) ATTACHING STRUCTURE FOR WALL SURFACE DECORATION BODY

(71) Applicant: YOSHIMITSU KOGYO INC., Fukui-shi, Fukui (JP)

(72) Inventor: Tomoyuki YOSHIDA, Fukui-shi, Fukui (JP)

(73) Assignee: YOSHIMITSU KOGYO INC., Fukui-shi, Fukui (JP)

(21) Appl. No.: 18/853,528

(22) PCT Filed: Jul. 25, 2023
(86) PCT No.: PCT/JP2023/027118

§ 371 Date: Oct. 2, 2024

(30) Foreign Application Priority Data
Nov. 25, 2022 (JP) 2022-188350

(51) Int. Cl. E04F 13/08

(52) U.S. Cl. CPC E04F 13/0801

(57) ABSTRACT

An object of the present invention is to provide an attaching structure for wall surface decoration body in which the wall surface decoration body can be arranged on a support with high precision and attached thereto with ease. In the attaching structure for wall surface decoration body, a pair of attaching members 4 is fixed to abutting portions 31 provided extending to both ends of a main body portion 30 of a wall surface decoration body 3, an attaching member 4 is made of an elastic plate and formed in a shape that it covers an end surface from a decorative surface side of the abutting portions 31 and protrudes toward an opposite side of the decorative surface, in a portion abutting on the decorative surface side, a fixing portion 40 to be fixed to the wall surface decoration body 3 is formed, and in a portion that protruding opposite to the decorative surface, a fitting portion 41 to fit an intersecting portion of wire rods is formed.

### TECHNICAL FIELD

The present invention relates to an attaching structure for attaching wall surface decoration body on a wall surface of a wall-like structure such as an exterior wall, an interior wall, a room divider, and a partition.

### BACKGROUND ART

In buildings such as houses, various kinds of wall-like structure such as exterior wall have been constructed from a structural or a design point of view, and in such wall-like structure, a decoration body has been arranged on a wall surface to improve functionality and exterior design thereof.

For such wall surface structure, the present inventor is proposing a wall surface structure which has a high decorative effect and is easy to repair, and a wall surface decoration body to be used therefor. A specific wall surface structure includes: a support member forming a wall surface by intersecting reinforcement members; and a plurality of wall surface decoration bodies arranged on the reinforcement members and attached to the support member, wherein the wall surface decoration body includes: a main body portion on which a decorative surface to be exhibited externally is formed; and a pair of supporting portions disposed at both ends of the main body portion and abutting on the support member, and wherein the supporting portions are attached to the support member so as to be adjacent to each other and the main body portion of the wall surface decoration body arranged in another arrangement direction is arranged so as to cover the adjacent supporting portions.

In Patent Document 1, arranging wall surface decoration bodies so that supporting portions are adjacent to each other and attaching them to a support member and arranging the wall surface decoration bodies so that the wall surface decoration bodies are arranged next to each other in another arrangement directions to cover the supporting portions one another, it enables to prevent the supporting portions that serve as a seam in arrangement directions from exhibiting externally and to exhibit an appearance like a woven structure continuing in different arrangement directions.

### PRIOR ART DOCUMENT

### Patent Document

PATENT DOCUMENT 1; Japanese Patent No. 6810942

### SUMMARY OF THE INVENTION

### Technical Problem

In a wall surface structure described in Patent Document 1, while a wall surface decoration body can be constituted of known materials used as wall surface materials such as a ceramic material, a resin material, and a metallic material, when attaching the wall surface decoration bodies made of such known materials to a support consisted of reinforcement members along arrangement directions, in order to exhibit an appearance like a woven structure continuing in different arrangement directions, the wall surface decoration bodies are required to be arranged linearly with high accuracy. However, for example, when manufacturing the wall surface decoration body using tile materials, etc., it is difficult to mass-produce and process it with high precision, and there is a problem that processing with high precision would increase the cost burden.

Therefore, an object of the present invention is to provide an attaching structure for wall surface decoration body in which the wall surface decoration body can be arranged on a support with high precision and attached thereto with ease.

### Means to Solve the Problem

An attaching structure for wall surface decoration body according to the present invention is the attaching structure for wall surface decoration body, in which a plurality of wall surface decoration bodies are attached to a support formed in a mesh shape by crossing wire rods, in arrangement directions along the wire rods, wherein the wall surface decoration body includes: a main body portion on which a decorative surface to be exhibited externally is formed; and a pair of abutting portions that is provided extending to both ends of the main body portion to abut on the support, wherein the wall surface decoration bodies arranged in the arrangement directions are attached to the support so that the abutting portions are adjacent to each other, wherein the main body portion of the wall surface decoration body arranged in another arrangement direction is arranged so that it covers the abutting portions arranged next to each other, wherein a pair of attaching members that is to be detachably attached to the wire rods is fixed to the abutting portions of the wall surface decoration body, respectively, and wherein an attaching member is made of an elastic plate and formed in a shape that it covers an end surface from a decorative surface side of an abutting portion and protrudes toward an opposite side of the decorative surface, in a portion abutting on the decorative surface side, a fixing portion to be fixed to the wall surface decoration body is formed, and in a portion protruding opposite to the decorative surface, a fitting portion to fit an intersecting portion of the wire rods is formed.

### Advantageous Effect of the Invention

According to the present invention having a configuration as described above, the attaching member made of an elastic plate is fixed to the abutting portion of the wall surface decoration body so as to cover an end surface from the decorative surface side of the abutting portion and protrude toward the opposite side of the decorative surface, thus, when the wall surface decoration bodies are arranged so that the abutting portions are next to each other, at each end of the abutting portions, attaching members that are fixed come to be attached thereto while being in a close contact with each other.

As a result, even if there is any variation in the size of the wall surface decoration body in the arrangement direction, the attaching members can abut each other due to their elastic deformation to adjust an arranged position of the abutting portion with respect to the intersecting portion of the wire rods, which could ensure an accurate attachment of the wall surface decoration body.

In addition, a fitting portion that fits to the intersecting portion of the wire rods is formed in the portion of the attaching member protruding opposite to the decorative surface, which would enable the wall surface decoration body to be securely attached by fitting its fitting portion to the intersecting portion of the wire rods, and to be attached detachably with ease.

### BRIEF DESCRIPTION OF THE DRAWINGS

FIG. 1 is a partial schematic diagram viewed from the front side related to an embodiment according to the present invention.

FIG. 2 is a partial schematic diagram viewed from the back side related to the embodiment shown in FIG. 1.

FIG. 3A and FIG. 3B are perspective views of appearance related to a wall surface decoration body.

FIG. 4A, FIG. 4B and FIG. 4C are front view, side view, and plan view related to an attaching member.

FIG. 5A and FIG. 5B are plan view and front view related to the wall surface decoration body to which the attaching member is fixed.

FIG. 6A and FIG. 6B are partially enlarged views showing a state that attaching members fit an intersecting portion of wire rods.

FIG. 7A and FIG. 7B are explanatory diagrams of fitting portions when they are attached to the intersecting portion of the wire rods in a state that adjacent fitting portions are contacted closely.

### SUMMARY OF THE INVENTION

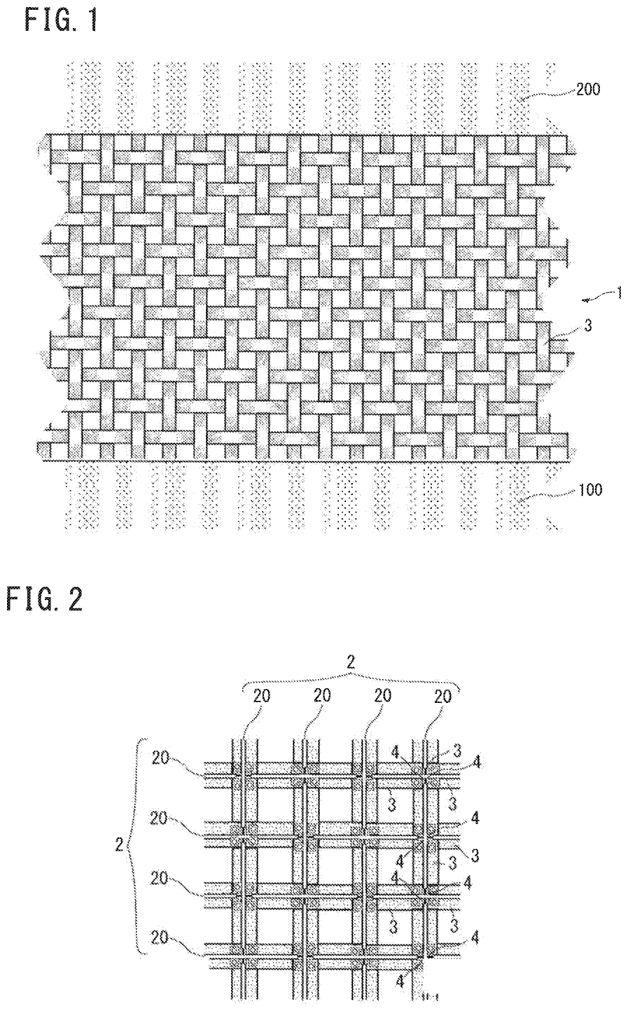

Hereinafter, the present invention will be described in detail based on an embodiment shown in the accompanying drawings. FIG. 1 is a partial schematic diagram viewed from the front side related to the wall surface structure using the embodiment according to the present invention, FIG. 2 is a partial schematic diagram viewed from the back side thereof.

In this embodiment, a wall surface structure 1 is built between foundations 100 and beams 200 and includes a support 2 formed in a mesh shape by crossing wire rods 20 constituting a wall surface, and a plurality of wall surface decoration bodies 3 each attached to the support 2 along an arrangement direction of a wire rod 20.

The support 2 is constituted by arranging the wire rods 20 in a mesh shape at equal intervals in a vertical direction and a left and right direction, using a rod-shaped reinforcement member as the wire rod 20. Further, a wall surface decoration body 3 is formed in a narrow strip to be arranged in the vertical direction or the left and right direction along the wall surface and to be attached to the wire rods 20.

It should be noted that the wall surface decoration bodies 3 are enough to be arranged in plural arrangement directions that are set to be intersected along the wall surface, and the arrangement directions are not limited to the vertical direction and the left and right direction. Further, the arrangement directions are not limited only to such orthogonal arrangement directions, but can be also set for arrangement directions with various intersection angles corresponding to a decorative design of the wall surface. Further, arrangement groups each consisting of the plurality of wall surface decoration bodies 3 in the arrangement directions are arranged at a predetermined interval, so that a gap is formed between the arrangement groups. Therefore, an open decorative design can be built which enables the other side of the wall surface structure to be visible, when executed on a partition or the like.

The support 2 can be formed by crossing the wire rods 20 made of known reinforcement members such as reinforcing bars and stainless-steel bars and arranging them in a plane shape. Further, when executing the wall surface structure on an exterior wall of a building, it would be enough that the support 2 may be built in a plane shape along the exterior wall and the built support 2 may be attached to a structural member of the exterior wall and fixed.

As the wall surface decoration body 3, it may be consisted of a known material to be used as a wall material, such as a ceramic material, a resin material, and a metallic material, and it may be also possible to use a combination of a plurality of types of materials. In addition, the decoration body made of different types of materials or materials of different colors may be used in combination as well.

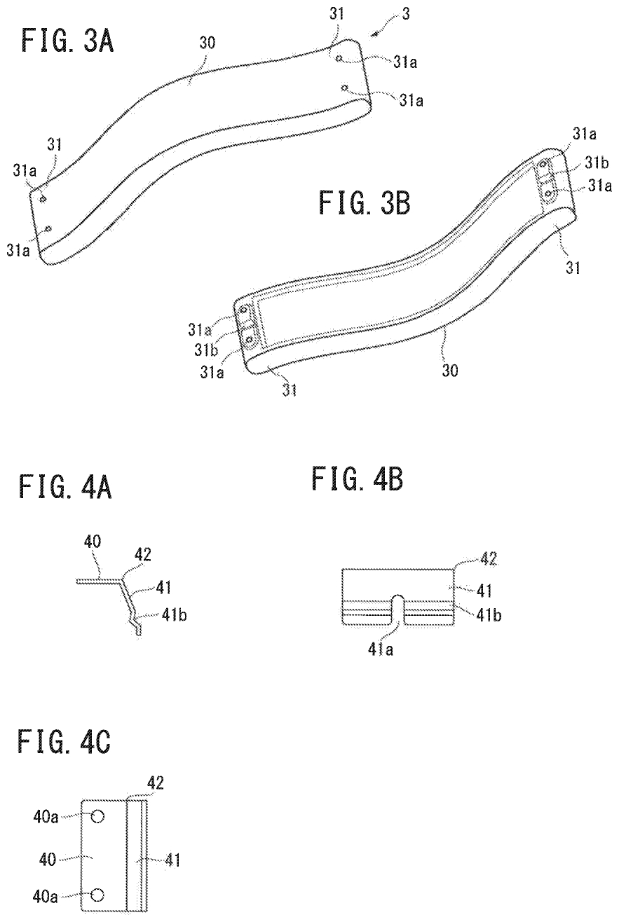

FIG. 3A and FIG. 3B are perspective views of an appearance related to the wall surface decoration body, FIG. 3A is a perspective view viewed from the decorative surface side, and FIG. 3B is a perspective view viewed from the opposite side of the decorative surface. The wall surface decoration body 3 includes a main body portion 30 formed with the decorative surface exhibiting as a wall surface, and a pair of abutting portions 31 disposed at both ends of the main body portion 30 to abut on the support 2. In this embodiment, the main body portion 30 is formed in a strip shape when viewed from the decorative surface side and is formed in a curved shape when viewed from the width direction.

In the wall surface decoration body 3, a distance between a plane on which the abutting portion 31 abuts on the wire rod 20 and the central portion of the main body portion 30 is set to be longer than a thickness of the abutting portion 31, thus, the abutting portion 31 of the wall surface decoration body 3 arranged in the other arrangement direction can be accommodated between the main body portion 30 of the wall surface decoration body 3 arranged in one arrangement direction and the support 2. Therefore, the wall surface decoration bodies 3 arranged in one arrangement direction are attached to the support 2 in such a way that the abutting portions 31 thereof are adjacent to each other, and the main body portion 30 of each wall surface decoration body 3 is arranged in the other arrangement direction so as to cover the abutting portions 31 arranged adjacent to each other together.

Thus, the wall surface decoration body 3 arranged in the vertical direction and the wall surface decoration body 3 arranged in the left and right direction come to be arranged such that the main body portion 30 and the abutting portions 31 are overlapped alternately at an intersection position. Still more, since the abutting portions 31 serving as a seam in each arrangement direction come to be covered with the main body portion 30, it would be visualized as if the wall surface decoration bodies 3 were arranged continuously in each arrangement direction, and exhibit an appearance like a plain weave structure of woven fabrics.

In the abutting portion 31 of the wall surface decoration body 3, a pair of attaching holes 31a is formed to penetrate in a thickness direction, and between the attaching holes 31a opening on the opposite side of the decorative surface, a groove portion 31b in which the wire rod 20 is to be fitted is formed.

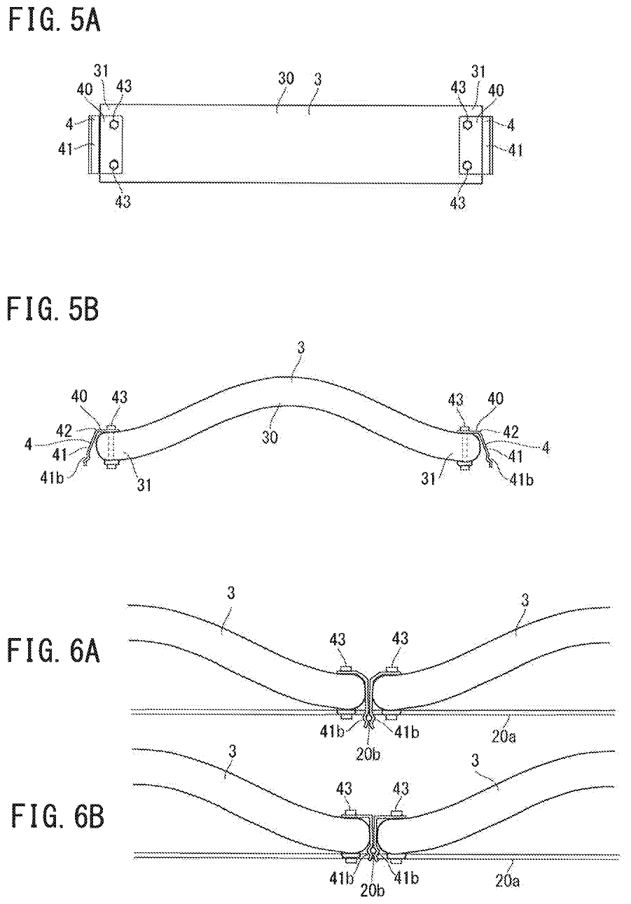

A pair of attaching members 4 that is detachably attached to the wire rods 20 is fixed to the abutting portions 31. FIG. 4A to 4C are front view (FIG. 4A), side view (FIG. 4B), and plan view (FIG. 4C) related to the attaching member 4. FIG. 5A to 5B are plan view (FIG. 5A) and front view (FIG. 5B) related to the wall surface decoration body 3 to which the attaching members 4 are fixed.

An attaching member 4 is made of a thin metal plate having elasticity, and is formed in a shape that covers an end surface of the abutting portion 31 from the decorative surface side and protrudes toward the opposite side of the decorative surface. Further, a portion abutting on the decorative surface side is formed with a fixing portion 40 fixed to the wall surface decoration body 3, and a portion protruding opposite to the decorative surface is formed with a fitting portion 41 to fit the intersecting portion of the wire rods 20.

Between the fixing portion 40 and the fitting portion 41, the plate is bent at a predetermined angle to form a corner portion 42, and when further bending and deforming elastically the corner portion 42 to approach the fitting portion 41 to the fixing portion 40, a biasing force to return the fitting portion 41 to its original position would be worked.

In the fixing portion 40, a pair of fixing holes 40a is formed in alignment with the pair of attaching holes 31a of the abutting portion 31, and a fixing member such as a screw would be attached in the attaching hole 31a to fix the fixing portion 40 to the decorative surface side of the abutting portion 31.

The fitting portion 41 is formed with a notch 41a in which a wire rod 20 is to be fitted along the arrangement direction of the wall surface decoration body 3 and a bending portion 41b in which the wire rod 20 along another arrangement direction is to be fitted. The notch 41a is formed by cutting out from the end at a predetermined length and at a width approximately the same as the diameter of the wire rod 20 in a direction perpendicular to the corner portion 42. The bending portion 41b is bent with three bending lines parallel to the corner portion 42 to form a groove of a triangular cross section capable of accommodating the wire rod 20.

Arranging the fixing portion 40 on the decorative surface side of the abutting portion 31 to align the fixing holes 40a with the attaching holes 31a, the attaching member 4 is fixed by a fixing member 43 consisting of a bolt and a nut. Inserting the bolt into the aligned fixing hole 41a and screwing the nut to the tip of the bolt protruding on the opposite side of the decorative surface of the abutting portion 31, the attaching member 4 can be fixed.

When fixing the attaching member 4, as shown in FIG. 5A to 5B, the fitting portion 41 becomes protruding opposite to the decorative surface to cover the end surface of the abutting portion 31, while a gap is formed between it and the end surface. Therefore, when attaching the fitting portion 41 to the intersecting portion of the wire rods 20, making the fitting portion 41 elastically deform so that it could closely contact with the end surface, the fitting portion 41 would be subject to the biasing force in the direction away from the end surface.

FIG. 6A to 6B are partially enlarged views showing a state that the attaching members fit the intersecting portion of the wire rods. FIG. 6A shows a state that the bending portions 41b fit a lower wire rod of intersecting wire rods, and FIG. 6B shows a state that the bending portions 41b fit an upper wire rod of intersecting wire rods.

The pair of attaching members 4 fixed to both ends of the wall surface decoration body 3 each fits the wire rod 20a that is along the arrangement direction in the notch 41a. At that time, the fitting portions 41 at both ends are each elastically deformed to closely contact with the end surface of the abutting portion 31, and the bending portions 41b are inserted inside (the side where each abutting portion 31 is disposed) the wire rods 20b on both sides that are each along another arrangement direction to fit the wire rods 20b from inside thereof. When making the bending portions 41b fit the lower wire rod, fitting can be carried out by elastically deforming as if the entire attaching member 4 were pulled.

In the attaching members 4 at both ends, each fitting portion 41 is subject to the biasing force toward the outside from the inside the wire rod 20b due to an elastic deformation of it, which would make the fitting portion 41 fit on the wire rod 20b while being always in pressure contact with the inner side of the wire rod 20b.

In this way, the wall surface decoration body 3 comes to be held between the wire rods 20b on both sides through the attaching members 4. Therefore, even if a dimensional error would occur in the wall surface decoration body 3, the dimensional error could be adjusted by an elastic deformation of the attaching member 4, which would ensure the attachment to the support 2.

Further, the fitting portions 41 of the attaching members 4 of adjacent wall surface decoration bodies 3 are inserted to hold the wire rod 20b therebetween while keeping the fitting portions 41 in a close contact with each other. Since notches 41a of the adjacent fitting portions 41 fit the common wire rod 20a, the fitting portions 41 may fit to hold the intersecting portion of the wire rods 20a and 20b in a stable manner without shifting thereof. Therefore, the wall surface decoration bodies 3 can be accurately arranged and attached linearly along the wire rod 20a or 20b, and it becomes possible to build the wall surface structure arranged in a geometrically orderly manner.

Fitting the fitting portions of the adjacent wall surface decoration bodies to the intersecting portion of the wire rods and attaching a fastening member to the fitting portions that are in an overlapped state, the fitting portions can be prevented from carelessly coming off the intersecting portion of the wire rods.

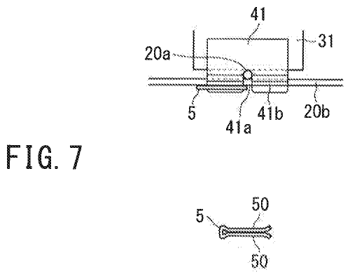

FIG. 7A to 7B are explanatory diagrams of fitting portions when they are attached to the intersecting portion of the wire rods in a state that adjacent fitting portions 41 are contacted closely. FIG. 7A is a partially enlarged view of the overlapped state of the fitting portions 41 viewed from the direction along the arrangement direction of the wall surface decoration body 3, wherein the wire rod 20a along the arrangement direction is fitted into the notch 41a of the fitting portion 41, the bending portions 41b fit the wire rod 20b, which is in the direction of intersecting with the wire rods 20a, so as to hold it therebetween. In this embodiment, a clip having a shape shown in FIG. 7B is used as a fastening member 5, and the fastening member 5 is attached to sandwich the lower end sides of the bending portions 41b. Clamping and fastening clamping portions 50 of the fastening member 5 on both sides of the overlapped bending portions 41b, the bending portions 41b can be reliably maintained in a fitting state on the wire rod 20b not to detach from it.

As described above, in the present invention, since the attaching member is attached to cover the end surfaces from the decorative surface side, the adjacent abutting portions are free from coming into direct contact with each other, and the position of the wall surface decoration body may be adjusted easily. Further, since the abutting portion of the wall surface decoration body is covered by the main body of the wall surface decoration body in another arrangement direction, the attaching member fixed to the decorative surface side of the abutting portion is not exposed to the surface of the wall surface structure, and the same decorative effect as before can be obtained.

### REFERENCE SIGNS

1 . . . Wall surface structure, 2 . . . Support, 20 . . . Wire rod, 3 . . . Wall surface decoration body, 30 . . . Main body portion, 31 . . . Abutting portion, 31a . . . Attaching hole, 4 . . . Attaching member, 40 . . . Fixing portion, 41 . . . Fitting portion, 41a . . . Notch, 41b . . . Bending portion, 42 . . . Corner portion, 43 . . . Fixing member, 5 . . . Fastening member

1. An attaching structure for wall surface decoration body, in which a plurality of wall surface decoration bodies are attached to a support formed in a mesh shape by crossing wire rods, in arrangement directions along the wire rods,
wherein the wall surface decoration body comprises: a main body portion on which a decorative surface to be exhibited externally is formed; and a pair of abutting portions that is provided extending to both ends of the main body portion to abut on the support,
wherein the wall surface decoration bodies arranged in the arrangement directions are attached to the support so that the abutting portions are adjacent to each other,
wherein the main body portion of the wall surface decoration body arranged in another arrangement direction is arranged so that it covers the abutting portions arranged next to each other,
wherein a pair of attaching members that is to be detachably attached to the wire rods is fixed to the abutting portions of the wall surface decoration body, respectively, and
wherein an attaching member is made of an elastic plate and formed in a shape that it covers an end surface from a decorative surface side of an abutting portion and protrudes toward an opposite side of the decorative surface, in a portion abutting on the decorative surface side, a fixing portion to be fixed to the wall surface decoration body is formed, and in a portion protruding opposite to the decorative surface, a fitting portion to fit an intersecting portion of the wire rods is formed.

2. The attaching structure for wall surface decoration body according to claim 1, wherein the fitting portion is formed with a notch in which a wire rod along the arrangement direction is to be fitted and a bending portion in which the wire rod along another arrangement direction is to be fitted.

3. The attaching structure for wall surface decoration body according to claim 1 or 2, comprising a fastening member to fasten fitting portions of the attaching members to the wire rods in an overlapped state, the fitting portions being fixed to the abutting portions disposed to be adjacent to the wire rods.

4. The attaching structure for wall surface decoration body according to claim 1 or 2, wherein the wall surface decoration body is configured that the main body portion is formed in a strip shape of a predetermined width when viewed from the decorative surface side and in curved shape when viewed from the width direction and the abutting portion is formed with an attaching hole for fixing the fixing portion.

5. The attaching for wall surface structure decoration body according to claim 1 or 2, wherein, in the abutting portion, a groove portion fitted to the wire rod is formed in a portion abutting on the support.
